(19) United States
(12) Patent Application Publication
(10) Pub. No.: US 2017/0329645 A1
(43) Pub. Date: Nov. 16, 2017

(54) APPARATUS AND METHOD FOR ADDING NODES TO A COMPUTING CLUSTER

(71) Applicant: Intel Corporation, Santa Clara, CA (US)

(72) Inventors: Qi CHEN, Hayward, CA (US); Liping ZHANG, Shanghai (CN); Kai X. MIAO, Beijing (CN); Jingxiang HE, Portland, OR (US)

(21) Appl. No.: 15/527,607

(22) PCT Filed: Dec. 19, 2014
(86) PCT No.: PCT/CN2014/094322

§ 371 Date: May 17, 2017

(51) Int. Cl. G06F 9/50; H04L 12/24

(52) U.S. Cl. CPC G06F 9/5077; H04L 41/0806; G06F 9/5044; G06F 2209/505

(57) ABSTRACT

Embodiments of apparatuses and methods for scaling up cluster nodes are described. In some embodiments, an apparatus may include a detector to detect hardware information of a node to be added to a domain of a computing cluster and a domain application configurator to generate a delta domain template for the node from a common domain template of the computing cluster and information of the domain. In some embodiments, the delta domain template may include information to provision applications required by the domain to the node. Other embodiments may be described and/or claimed.

### FIELD OF THE INVENTION

The present disclosure relates generally to the technical field of computing, and more particularly, to apparatuses and methods for adding nodes to a computing cluster.

### BACKGROUND

The background description provided herein is for generally presenting the context of the disclosure. Unless otherwise indicated herein, the materials described in this section are not prior art to the claims in this application and are not admitted to be prior art or suggestions of the prior art by inclusion in this section.

Big data may mean a collection of data sets that is difficult to be processed using traditional data processing applications and computing hardware. A computing cluster (hereinafter, simply “cluster”) may comprise many connected computers (also referred to as “nodes”) that work together to solve problems associated with big data. Apache Hadoop is one of the software frameworks for building a cluster to store and process big data with distributed nodes. A node may perform the same or similarly computing tasks as another node, controlled and/or scheduled by Hadoop.

To scale up a cluster, adding nodes becomes an important step for big data cluster management. Conventional practice for adding a new node may require a system administrator to execute various sequential operations, which could be slow and costly.

As an example, expanding a Hadoop cluster and installing cluster applications may include many complex and lengthy operations.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example system configuration for scaling up a cluster with additional nodes, incorporating aspects of the present disclosure, in accordance with various embodiments.

FIG. 2 is a schematic diagram illustrating an example node and an example commissioner configured for provisioning the node, incorporating aspects of the present disclosure, in accordance with various embodiments.

FIG. 3 is a flow diagram of an example process for provisioning an example node to the cluster, which may be practiced by an example commissioner, incorporating aspects of the present disclosure, in accordance with various embodiments.

FIG. 4 is a flow diagram of an example process for generating a delta domain template, which may be practiced by an example commissioner, incorporating aspects of the present disclosure, in accordance with various embodiments.

FIG. 5 illustrates an example computing device suitable for practicing the present disclosure, in accordance with various embodiments.

FIG. 6 illustrates an article of manufacture having programming instructions, incorporating aspects of the present disclosure, in accordance with various embodiments.

### DETAILED DESCRIPTION

Embodiments of apparatuses and methods for scaling up cluster nodes are described. To scale up a computing cluster, adding nodes is an important part of big data cluster management. In some embodiments, a commissioner server may include a detector to detect hardware information of a node to be added to a domain of a computing cluster and a domain application configurator to generate a delta domain template for the node from a common domain template of the computing cluster and information of the domain. In some embodiments, the delta domain template may include information to provision applications required by the domain to the node. These and other aspects of the present disclosure will be more fully described below.

In the following detailed description, reference is made to the accompanying drawings, which form a part hereof, wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

Reference in the description to one embodiment or an embodiment means that a particular feature, structure, or characteristic described in connection with the embodiment is included in at least one embodiment of the invention. The description may use the phrases “in one embodiment,” “in another embodiment,” “in some embodiments,” “in embodiments,” “in various embodiments,” or the like, which may each refer to one or more of the same or different embodiments. Furthermore, the terms “comprising,” “including,” “having,” and the like, as used with respect to embodiments of the present disclosure, are synonymous.

In embodiments, the term “module” may refer to, be part of, or include an application specific integrated circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. In embodiments, a module may be implemented in firmware, hardware, software, or any combination of firmware, hardware, and software.

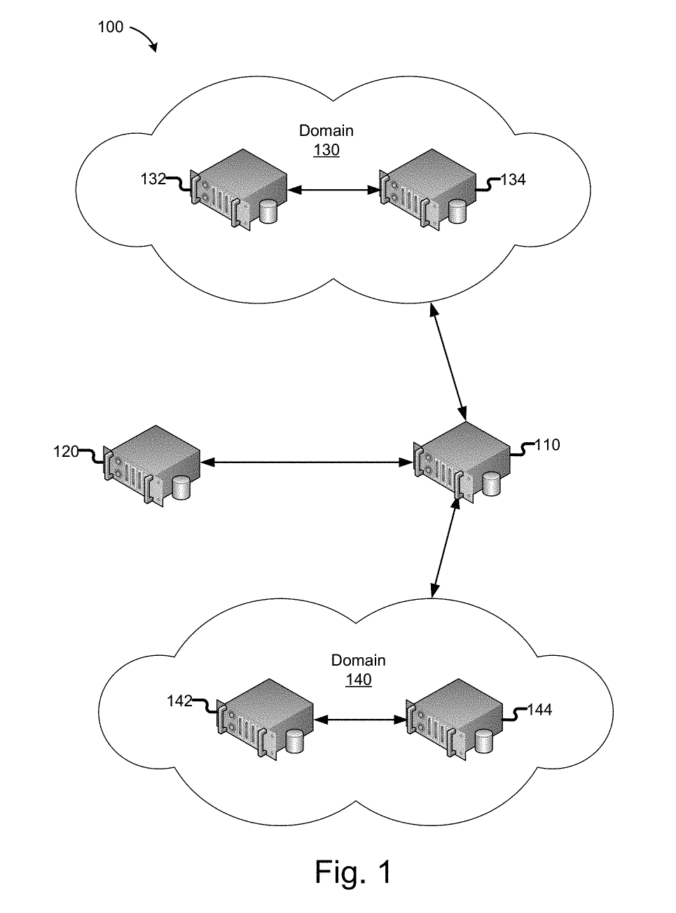

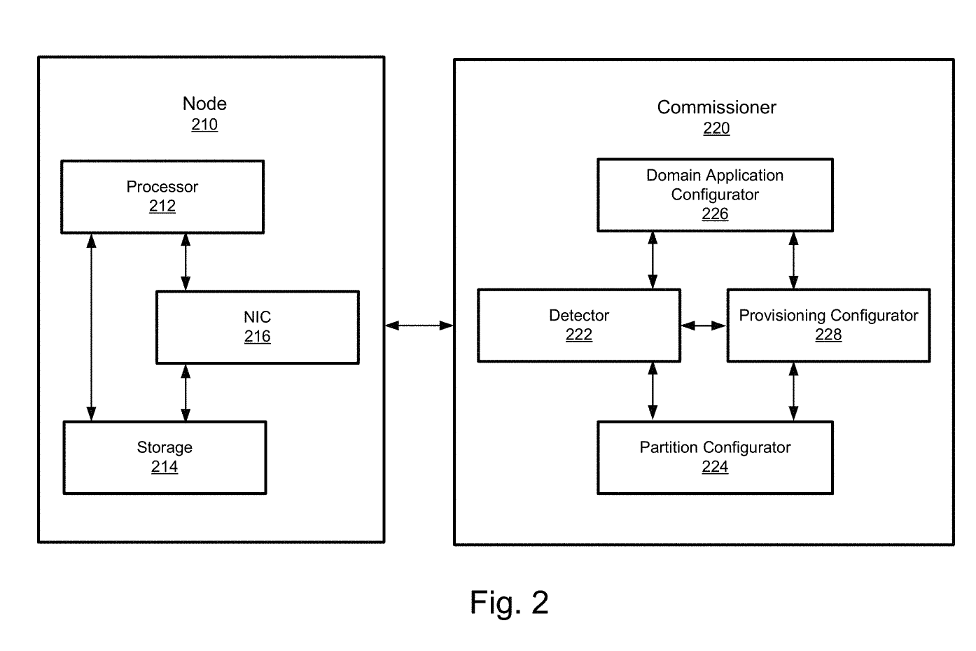

Referring now to FIG. 1, an example system configuration for scaling up a cluster with additional nodes, in accordance with various embodiments, is illustrated. Cluster 100 may include various computing devices, where some or all of these devices may have direct or indirect access via networking to each other, e.g., via a local area network (LAN), wireless LAN (WLAN), or even a cellular network. In various embodiments, commissioner server 110 (hereinafter, simply “commissioner”) may be configured to add new node 120 to domain 130. Domain 130 may already include node 132 and node 134. Alternatively, commissioner 110 may add new node 120 to domain 140, which already has node 142 and node 144. As will be described in more detail below, commissioner 110, node 120, and other nodes may be respectively incorporated with corresponding teachings of the present disclosure to enable scaling up cluster 100 with additional nodes. In various embodiments, commissioner 110, node 120, or other nodes may be equipped with suitable modules, such as those illustrated in connection with FIG. 2, to enable scaling up of a cluster with additional nodes.

In some embodiments, commissioner 110 and node 120 may be configured to communicate with each other using Internet Protocols (IP) over the Internet. In other embodiments, commissioner 110 and node 120 may be configured, e.g., during their initial communication phase, to communicate with each other using dedicated short-range communications (DSRC), near field communication (NFC), or Bluetooth and Wi-Fi connections. Recognizing that the foregoing communication technologies were merely indicative of potential underlying communication technologies, which may be used between these nodes, in other embodiments, different communication technologies may be used.

In embodiments, cluster 100 may include one or more wireless and/or wired networks (not shown) to operatively couple nodes together. Cluster 100 may be accessed via public and/or private networks, such as, but not limited to, the Internet, a telephone network (e.g., public switched telephone network (PSTN)), a local area network (LAN), a wide area network (WAN), a cable network, an Ethernet network, and so forth. Wireless communication networks may include various combinations of wireless personal area networks (WPANs), wireless local area networks (WLANs), wireless metropolitan area networks (WMANs), and/or wireless wide area networks (WWANs).

Big data, commonly seen in Internet search, finance and business informatics, meteorology, complex physics simulations, and life-science and environmental research, is difficult to work with using most conventional relational database management systems and/or statistics and visualization packages. Cluster 100 may provide vast parallel computing power by running hundreds or even thousands of nodes to solve some of computing problems related to big data, e.g., to discover knowledge and derive new information from analysis of a large set of related data. One challenge here is expediently and economically scaling up cluster nodes for cluster 100.

In various embodiments, as shown, nodes in cluster 100 may be divided into different domains. In some embodiments, a domain in cluster 100 may be any collection of nodes and/or data sets that are logically grouped together for solving a task or subtask associated with the data sets. In some embodiments, a task may include capturing, analyzing, searching, storing, transferring, or visualizing a data set. Therefore, a domain may include a group of nodes dedicated to analyzing the data set, whereas another domain may include another group of nodes specialized in visualizing the outcome of such analysis. In such case, node 120 may be commissioned to a domain that needs a new node to complete the specialized domain task, e.g., based on workload in the domain.

In some embodiments, a domain may be any collection of nodes and/or data sets that are physically grouped together for solving a task or subtask associated with the data sets. In some embodiments, a domain may be associated with a location, e.g., a rack for physically hosting the group of nodes or a network switch for the group of nodes. In this case, node 120 may be configured to join a domain based on such location awareness in cluster 100, e.g., to reduce backbone traffic.

In some embodiments, a domain may be any collection of nodes and/or data sets that are logically grouped together for an entity. As an example, the entity may be a business entity utilizing cluster 100 for its various computing tasks. Various domains may be established catering to different business functions associated with the business entity, such as accounting domain, inventory domain, customer relationship management (CRM) domain, etc.

There are many operations that may be involved for adding a new node to a domain of cluster 100. In various embodiments, commissioner 110 may create a disk image, containing the contents and structure of one or more disk volumes, for the new node. The disk image may include a partition plan based on dynamically detected disk information of the new node, such as the number of disk and the size of each disk. The disk image may include different applications based on customized domain templates for different cluster domains. In some embodiments, adding the new node may further involve installing an operating system (OS) on the new node, checking disk size, making partition configurations, verifying file system, ascertaining other hardware information of the new node for commissioner 110 to decide how to schedule and assign disk partitions for the new node. In some embodiments, commissioner 110 may be configured to use a default partition scheme. In other embodiments, commissioner 110 may be configured to dynamically create a customized partition scheme to optimize the disk usage. Moreover, commissioner 110 may configure different cluster applications for node 120 based on different disk information (e.g., the disk size) as well as information of the domain where node 120 is supposed to join.

In various embodiments, commissioner 110 may be configured to send node 120 an operating system to detect and collect hardware information of node 120. In embodiments, a primitive operating system capable of collecting the hardware information of node 120 would suffice. Once the hardware information of node 120 is harvested, commissioner 110 may devise a customized partition plan for node 120 based on its hardware information. Subsequently, the customized partition plan may be executed in node 120. Further, commissioner 110 may generate a delta domain template (e.g., including configuration information for specific applications in the CRM domain) for node 120 based on a common domain template (e.g., including configuration information for general applications used by any domain), domain information of the domain that node 120 is to be added to (e.g., a statistical computing and graphics environment may be additionally required for the CRM domain), and hardware information of node 120. Further, commissioner 110 may be configured to provision or cause to be provisioned selected cluster applications required for node 120 to join the chosen domain based at least in part on the delta domain template created for node 120.

In cluster 100, with delta domain templates generated by commissioner 110, a new node may be customized and grouped into different domains. Similarly, commissioner 110 may also generate delta domain templates for any nodes in cluster 100 to transfer from one domain to another domain, e.g., using a similar procedure as described above. As an example, domain 130 may be a billing domain, which requires a Structured Query Language (SQL) interface to interact with a relational database system; whereas domain 140 may be a CRM domain, which requires an R language interface for statistical computing and graphics. Thus, when node 132 needs to be transferred from domain 130 to domain 140, commissioner 110 may treat node 132 as a naked node and cause node 132 to be provisioned in a procedure similarly described in connection to node 120 in some embodiments. However, in other embodiments, commissioner 110 may generate the delta domain template for node 132 additionally based on the existing computing environment already set up in node 132. In this instance, commissioner 110 may compare the previous delta domain template used to commission node 132 with the common domain template used for domain 140, and generate the new delta domain template accordingly. Therefore, node 132 may be re-commissioned to domain 140 with reduced workload for making changes.

In various embodiments, commissioner 110 may optimize a partition plan for a node, reduce disk formatting and partition time, accelerate OS installation process, and optimize disk usage on the node being added to a domain. Thus, commissioner 110 may expeditiously add a naked node to cluster 100 or re-commission a node to a different domain. Further, commissioner 110 may improve cluster building and nodes' commissioning performance by using customized delta domain templates to accelerate cluster application installation. Resultantly, a large number of nodes' repositioning may be accomplished in short time.

Referring now to FIG. 2, an example implementation of node 210 and commissioner 220 for provisioning node 210, incorporating aspects of the present disclosure, in accordance with various embodiments, is illustrated. In embodiments, commissioner 220 may be a node in a cluster, such as commissioner 110 in FIG. 1, designated to commission other nodes to join various domains in the cluster. In embodiments, commissioner 220 may be a distributed system with various components or subsystems distributed at various nodes. In embodiments, node 210 may be similar to one of the nodes depicted in FIG. 1, e.g., node 120 or node 132, which needs to join a domain in the cluster.

In various embodiments, node 210 may include processor 212, storage 214, and network interface controller (NIC) 216. In various embodiments, commissioner 220 may include detector 222, partition configurator 224, domain application configurator 226, and provisioning configurator 228. In embodiments, commissioner 220, in synergy with node 210, may enable scaling up cluster nodes.

In various embodiments, when adding a naked node, e.g., node 210, into an existing Hadoop cluster, commissioner 220 may detect hardware information (e.g., disk number), setup computing environment, and configure parameters for various services and applications in node 210. Further, commissioner 220 may facilitate node 210 to install OS and various Hadoop based applications (e.g., face recognition, batch indexing, batch processing, searching, etc.), and enable node 210 to start local services, Hadoop services, and application services.

In various embodiments, node 210 may utilize one or more wireless or wired networks to communicate with commissioner 220. Those networks may include public and/or private networks, such as, but not limited to, local area networks (LANs), wide area networks (WANs), or the Internet. In some embodiments, those networks may include wireless networks, like wireless personal area networks (WPANs), wireless LANs (WLANs), wireless metropolitan area networks (WMANs), or wireless wide area networks (WWANs). In some embodiments, those networks may also include cellular networks.

In various embodiments, detector 222 may remotely detect the hardware information of node 210 via networking. As an example, detector 222 may communicate with NIC 216 in node 210 to gather disk information of storage 214, such as the numbers of disks and their respective disk size. In some embodiments, detector 222 may also use a primitive OS or an application to gather the hardware information of node 210, including the numbers of disk, size of each disk, memory size, processing capabilities, etc. In some embodiments, the primitive OS may include a minimal kernel or microkernel that may be installed to node 210 to discover that node's hardware.

In various embodiments, partition configurator 224 may configure a partition plan for node 210 based on the detected hardware information. In some embodiments, the partition plan may be used to automatically partition storage 214 for different applications. As an example, the partition plan may reserve a disk of storage 214 for the OS and another disk for Hadoop distributed file system (HDFS). In some embodiments, partition configurator 224 may generate partition plans for a group of nodes and facilitate them to execute those partition plans.

In various embodiments, domain application configurator 226 may generate a delta domain template for node 210 based on domain information of the domain for node 210 to join and a common domain template. The common domain template may be relatively static and stable while the delta domain template for node 210 may be dynamic calculated. The common domain template may be used to set up a basic computing environment for various cluster applications and start basic local services (e.g., basic Hadoop services).

The delta domain template may be used for node 210 to start specified delta domain applications compared to the basic common template. As an example, the delta domain template may include a special statistics and visualization package required by the domain for node 210 to join, which otherwise may not be required by another domain. For a Hadoop cluster, the delta domain template may specify whether additional software packages in the Hadoop ecosystem may be required for the domain, such as Apache Pig, Apache Hive, Apache HBase, Apache Spark, and others. In various embodiments, different delta domain templates may start different groups of applications. Thus, dynamically calculated and generated delta domain templates may be used to customize nodes for their respective domains.

In various embodiments, provisioning configurator 228 may facilitate node 210 to install and configure various cluster applications based on the delta domain template. As an example, provisioning configurator 228 may select a suitable operating system, e.g., SUSE, RHEL, Ubuntu, etc., for node 210 based on the domain for node 210 to join. As another example, provisioning configurator 228 may group service processes and parameters, customize access paths based on different applications specified in the delta domain template. In various embodiments, provisioning configurator 228 may monitor and manage the commission process for node 210, e.g., according to the delta domain template for node 210. In some embodiments, provisioning configurator 228 may also save the delta domain template for node 210, which may be reused to commission another identical node, or used to transfer node 210 to another domain in the future.

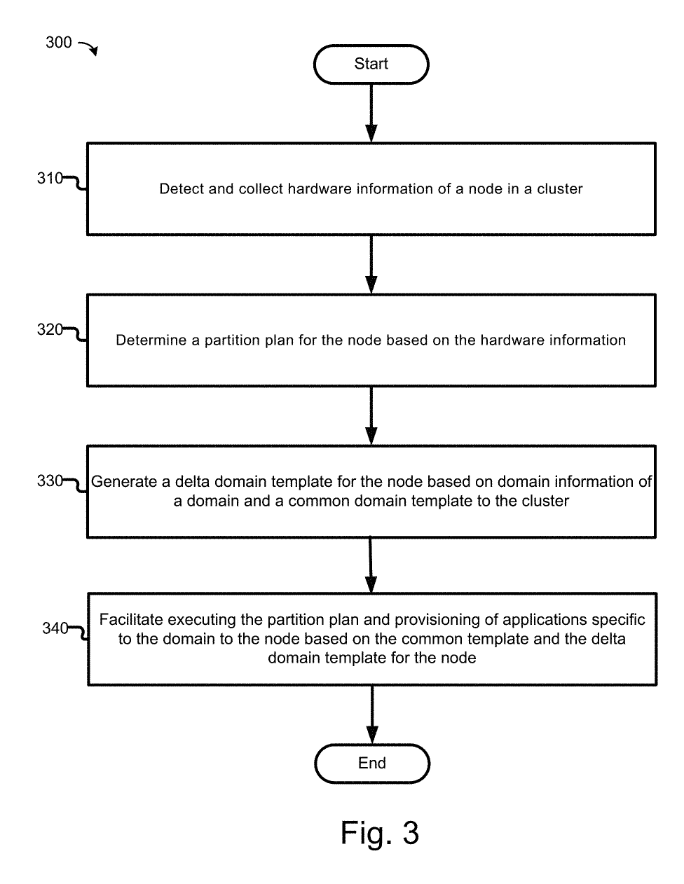

Referring now to FIG. 3, it is a flow diagram of an example process for scaling up a cluster with additional nodes, which may be practiced by an example device in accordance with various embodiments. The process 300 may be performed by processing logic that comprises hardware (e.g., circuitry, dedicated logic, programmable logic, microcode, etc.), software (e.g., instructions run on a processing device to perform hardware simulation), or a combination thereof. The processing logic may be configured for facilitating scaling up a cluster with additional nodes. As such, process 300 may be performed by a computing device, e.g., commissioner 110 of FIG. 1 or commissioner 220 of FIG. 2, to implement one or more embodiments of the present disclosure. In embodiments, various blocks in FIG. 3 may be combined or arranged in any suitable order, e.g., according to the particular embodiment for adding nodes.

In embodiments, the process may begin at block 310, where hardware information of a node to be added into a domain of a cluster may be detected and collected. In various embodiments, a primitive OS may be used to detect the hardware information of the node. The primitive OS may be configured to detect and collect hardware information including disk number, size, and memory size. In some embodiments, the primitive OS may include a minimal kernel or microkernel that may be installed to the node to directly discover that node's hardware. In some embodiments, the primitive OS may not need to be installed to the node, but may communicate with the node remotely via the network interface controller (NIC) of the node to gather the basic hardware information of the node.

Next, at block 320, a partition plan for the node based on the detected hardware information may be determined. In some embodiments, the detected hardware information may be used to devise a partition plan for better disk usage and data application location to improve performance. As an example, if there are N applications to be installed to a new node in a Hadoop cluster, and the new node is detected having K disks, M memory, and T total storage, then for the first disk, the partition plan may include (N+4) partitions; for rest of the disks, the partition plan may include (N+2) partitions on each disk. Moreover, the partition plan may reserve (T*⅕) storage space for the OS in the first partition; ((T−0.2*T−0.25*M)*⅕) storage space for Hadoop local computing in the second partition; ((T−0.2*T−0.25*M)*½) storage space for Hadoop shared storage, e.g., HDFS data, in the third partition: (⅓*(T−0.2*T−0.25*M)/N) storage space for each application for the following N partitions. Further, the partition plan may reserve (M*¼) storage space as swap. For the rest of (K−1) disks, (⅕*T) storage space may be reserved for Hadoop local computing like the first partition; (½*T) may be reserved for Hadoop shared storage, e.g., HDFS data, as the second partition; and (⅓*T/N) may be reserved for each application for the following N partitions. In various embodiments, partition plans for multiple nodes may be executed in parallel to expedite the process for provisioning the multiple nodes.

Next, at block 330, a delta domain template may be generated for the node based on domain information of a domain and a common domain template to the cluster. In various embodiments, the common domain template may be relatively static to the cluster, which may be used to set up basic applications' environment and configurations, start basic local services, e.g., start basic Hadoop services. As an example, when the cluster is a Hadoop cluster, the common template may include setup information for a Hadoop distributed file system (HDFS), a MapReduce engine, a Hadoop YARN, and common libraries and utilities needed by Hadoop. Therefore, a node may at least be equipped with a distributed file-system, a resource-management platform, and a programming model for large-scale data processing.

The delta domain template may be dynamic calculated based on the domain information and the common domain template. The delta domain template may be used to start specified delta domain applications compared to the common domain template. As an example, the delta domain template may additionally include configuration information for a statistical computing module. As another example, the delta domain template may include configuration information for a machine-learning module. As yet another example, the delta domain template may include configuration information for a data serialization module. As yet another example, the delta domain template may include configuration information for a graph processing module. Thus, different delta domain templates may start different groups of applications. In various embodiments, delta domain templates may be dynamically calculated and generated. In some embodiments, delta domain templates may reduce interference among different domain groups.

Next, at block 340, the partition plan may be executed, and applications specific to the domain to the node may be provisioned based on the common template and/or the delta domain template for the node. In some embodiments, e.g., in a Hadoop cluster, a new node may be customized based on the delta domain template and join a particular domain, by executing the partition plan and installing and configuring various applications to the node based at least in part on the delta domain template.

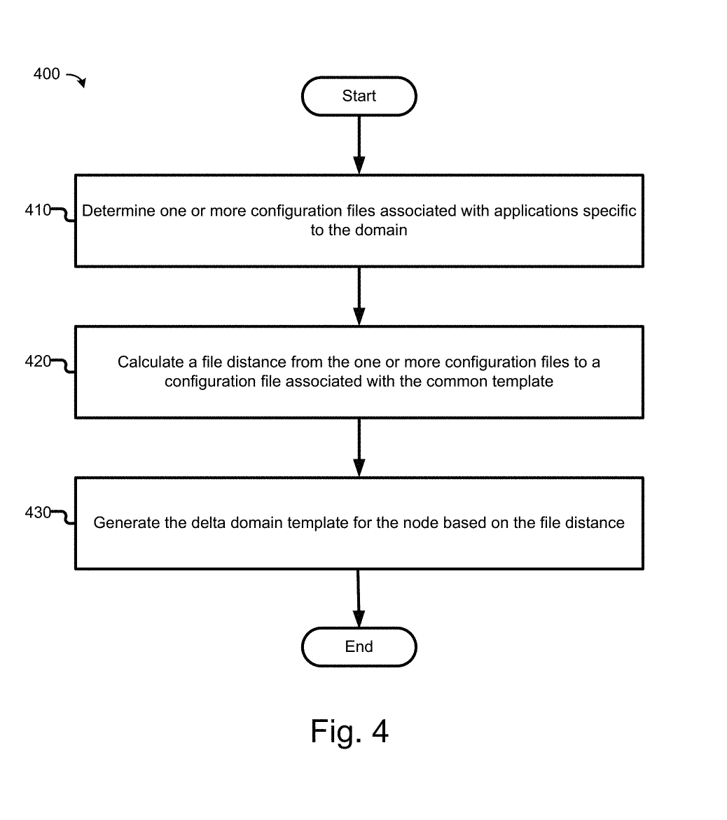

Referring now to FIG. 4, it is a flow diagram of another example generating a delta domain template, in accordance with various embodiments. In some embodiments, process 400 may correspond to block 330 of FIG. 3. The process 400 may be performed by processing logic that comprises hardware (e.g., circuitry, dedicated logic, programmable logic, microcode, etc.), software (e.g., instructions run on a processing device to perform hardware simulation), or a combination thereof. The processing logic may be configured for facilitating scaling up cluster nodes. As such, process 400 may be performed by a computing device, e.g., commissioner 110 of FIG. 1 or commissioner 220 of FIG. 2, to implement one or more embodiments of the present disclosure. In embodiments, various blocks in FIG. 4 may be combined or arranged in any suitable order, e.g., according to the particular embodiment to scaling up cluster nodes.

In embodiments, the process may begin at block 410, where one or more configuration files associated with applications specific to the domain may be determined. Extensible markup language (XML) may be used in some embodiments to describe or encode configuration files in a format that is machine-readable. In various embodiments, a configuration file associated with an application may supply installation or configuration options for properly installing and configuring the application for the domain. In various embodiments, the configuration file may be customized based on the tasks running in the domain. In various embodiments, the configuration file may be encoded with another markup language other than XML or in other data serialization formats, e.g., JavaScript object notation (JSON) or YAML.

Next, at block 420, a file distance from the one or more configuration files to the configuration file associated with the common template may be calculated. In various embodiments, a file distance may represent the difference between one file and another file, one file and a group of other files, or one group of files and another group of files. In some embodiments, a file distance may include differences between text files (e.g., two XML files) obtained on a line by line comparison, e.g., using techniques to compute the longest common subsequence (LCS), or using any other known methods for comparison. In some embodiments, the XML file distances may be computed from different domain applications' XML configuration files to the XML file associated with the common domain template. In other embodiments, similar file distances may be calculated based on the underlying encoding scheme or technology associated with these configuration files.

Next, at block 430, the delta domain template for the node based on the file distance may be generated. In some embodiments, the delta domain template may only retain the differences between two configuration files. In other embodiments, the delta domain template may be the result of merging domain-specific configuration files with the common domain template.

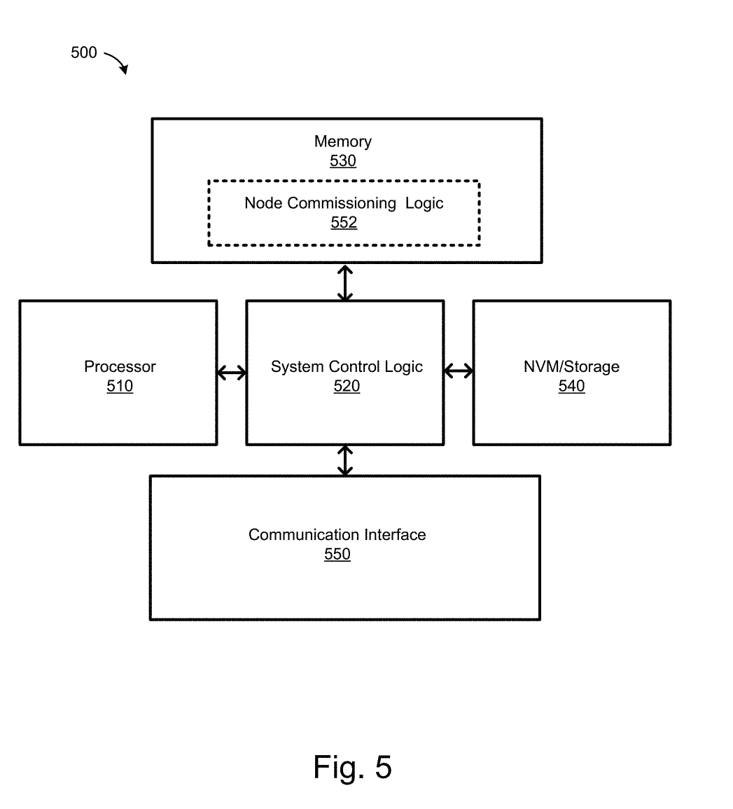

FIG. 5 illustrates an embodiment of a computing device 500 suitable for practicing embodiments of the present disclosure. Computing device 500 may be any computing device that is within a user's reach (e.g., a device that the user carries, wears, touches, gestures to, etc.), in forms such as a smartphone, a tablet, a laptop, a wearable device, a server, etc. As illustrated, computing device 500 may include system control logic 520 coupled to processor 510, to system memory 530, to non-volatile memory (NVM)/storage 540, and to communication interface 550. In various embodiments, processor 510 may include one or more processor cores.

In embodiments, communication interface 550 may provide an interface for computing device 500 to communicate with the variety of nodes in a cluster as previously discussed in connection with FIG. 1. In embodiments, communication interface 550 may provide an interface for computing device 500 to communicate over one or more network(s) and/or with any other suitable device. Communication interface 550 may include any suitable hardware and/or firmware, such as a network adapter, a network interface card, one or more antennas, wireless interface(s), and so forth. In various embodiments, communication interface 550 may include an interface for computing device 500 to use radio-frequency identification (RFID), near field communication (NFC), optical communications, or other similar technologies to communicate directly (e.g., without an intermediary) with another device. In various embodiments, communication interface 550 may interoperate with radio communications technologies such as, for example, Wideband Code Division Multiple Access (WCDMA), Global System for Mobile Communications (GSM), Long Term Evolution (LTE), Bluetooth®), Zigbee, and the like.

In embodiments, communication interface 550 may include, in particular, the logic to commission a node to a domain in a cluster as earlier described, collectively denoted as node commissioning logic 552. Node commissioning logic 552 may include instructions that, when executed by processor 510, result in computing device 500 providing scaling up cluster nodes, such as, but not limited to, processes 300 and 400.

In embodiments, node commissioning logic 552 may include instructions that, when executed by processor 510, result in computing device 500 performing various functions associated with detector 222, partition configurator 224, domain application configurator 226, and provisioning configurator 228 in connection with FIG. 2.

In some embodiments, system control logic 520 may include any suitable interface controllers to provide for any suitable interface to the processor 510 and/or to any suitable device or component in communication with system control logic 520. System control logic 520 may also interoperate with a display (not shown) for the display of information, such as to a user. In various embodiments, the display may include one of various display formats and forms, such as, for example, liquid-crystal displays, cathode-ray tube displays, e-ink displays, projection displays. In various embodiments, the display may include a touch screen.

In some embodiments, system control logic 520 may include one or more memory controller(s) (not shown) to provide an interface to system memory 530. System memory 530 may be used to load and store data and/or instructions, for example, for computing device 500. System memory 530 may include any suitable volatile memory, such as dynamic random access memory (DRAM), for example.

In some embodiments, system control logic 520 may include one or more input/output (I/O) controller(s) (not shown) to provide an interface to NVM/storage 540 and communication interface 550. NVM/storage 540 may be used to store data and/or instructions, for example. NVM/storage 540 may include any suitable non-volatile memory, such as flash memory, for example, and/or may include any suitable non-volatile storage device(s), such as one or more hard disk drive(s) (HDD), one or more solid-state drive(s), one or more compact disc (CD) drive(s), and/or one or more digital versatile disc (DVD) drive(s), for example. NVM/storage 540 may include a storage resource that is physically part of a device on which computing device 500 is installed or it may be accessible by, but not necessarily a part of, computing device 500. For example, NVM/storage 540 may be accessed by computing device 500 over a network via communication interface 550. In various embodiments, NVM/storage 540 may include the storage 214 of FIG. 2.

In some embodiments, processor 510 may be packaged together with memory having system control logic 520 and/or logic of node commissioning logic 552. In some embodiments, at least one of the processor(s) 510 may be packaged together with memory having system control logic 520 and/or logic of node commissioning logic 552 to form a System in Package (SiP). In some embodiments, processor 510 may be integrated on the same die with memory having system control logic 520 and/or logic of node commissioning logic 552. In some embodiments, processor 510 may be integrated on the same die with memory having system control logic 520 and/or node commissioning logic 552 to form a System on Chip (SoC).

Depending on which modules of node 210 or commissioner 220 in connection with FIG. 2 are hosted by computing device 500, the capabilities and/or performance characteristics of processor 510, system memory 530, and so forth, may vary. In various implementations, computing device 500 may be a mobile computing device or a server, enhanced with the teachings of the present disclosure.

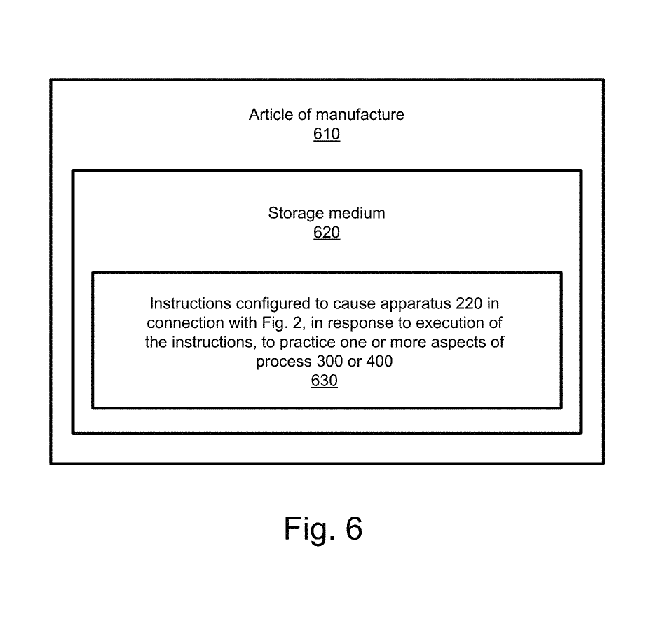

FIG. 6 illustrates an article of manufacture 610 having programming instructions, incorporating aspects of the present disclosure, in accordance with various embodiments. In various embodiments, an article of manufacture may be employed to implement various embodiments of the present disclosure. As shown, the article of manufacture 610 may include a computer-readable non-transitory storage medium 620 where instructions 630 are configured to practice embodiments of or aspects of embodiments of any one of the processes described herein. The storage medium 620 may represent a broad range of persistent storage media known in the art, including but not limited to flash memory, dynamic random access memory, static random access memory, an optical disk, a magnetic disk, etc. Instructions 630 may enable an apparatus, in response to their execution by the apparatus, to perform various operations described herein. As an example, storage medium 620 may include instructions 630 configured to cause an apparatus, e.g., commissioner 220, to practice some aspects of scaling up cluster nodes, as illustrated in process 300 of FIG. 3, in accordance with embodiments of the present disclosure. As another example, storage medium 620 may include instructions 630 configured to cause an apparatus, e.g., commissioner 220, to practice some aspects of scaling up cluster nodes, as illustrated in process 400 of FIG. 4, in accordance with embodiments of the present disclosure. In embodiments, computer-readable storage medium 620 may include one or more computer-readable non-transitory storage media. In other embodiments, computer-readable storage medium 620 may be transitory, such as signals, encoded with instructions 630.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

The following paragraphs describe examples of various embodiments.

Example 1 is an apparatus for computing, which may include a detector to detect hardware information of a node to be added to a domain of a computing cluster; and a domain application configurator, coupled to the detector, to generate a delta domain template for the node from a common domain template of the computing cluster and information of the domain, the delta domain template to include information to provision a plurality of applications to the node, the plurality of applications to be offered by nodes of the domain.

Example 2 may include the subject matter of Example 1, and may further include a partition configurator, coupled to the detector, to determine a partition plan with a plurality of partitions based on the hardware information, wherein the partition configurator is to determine a partition of the plurality of partitions to install the plurality of applications.

Example 3 may include the subject matter of Example 1 or 2, and may further specify that the computing cluster is a Hadoop cluster, wherein the common domain template includes setup information for a Hadoop distributed file system, and wherein the partition configurator is to determine another partition of the plurality of partitions to install the Hadoop distributed file system.

Example 4 may include any subject matter of Examples 1-3, and may further include a provisioning configurator, coupled to the domain application configurator, to facilitate the node to install and configure the plurality of applications based on the delta domain template.

Example 5 may include any subject matter of Examples 1-4, and may further specify that the domain application configurator is to determine one or more configuration files associated with the plurality of applications.

Example 6 may include the subject matter of Example 5, and may further specify that the domain application configurator is to calculate a file distance from at least one of the one or more configuration files to the common domain template.

Example 7 may include the subject matter of Example 6, and may further specify that the domain application configurator is to generate the delta domain template based on the file distance.

Example 8 may include the subject matter of Example 6, and may further specify that the domain application configurator is to generate the delta domain template by merging the at least one of the one or more configuration files to the common domain template.

Example 9 is a method for computing, which may include detecting, by a commissioning node in a computing cluster, hardware information of a node to be added to a domain of the computing cluster; generating, by the commissioning node, a delta domain template for the node based on a common domain template, domain information of the domain, and the hardware information; and provisioning or causing to be provisioned, by the commissioning node, a plurality of applications to the node based at least in part on the delta domain template, the plurality of applications to be offered by nodes of the domain.

Example 10 may include the subject matter of Example 9, and may further include determining, by the commissioning node, a partition plan with a plurality of partitions based on the hardware information; and determining, by the commissioning node, one of the plurality of partitions to install the plurality of applications.

Example 11 may include the subject matter of Example 9 or 10, and may further specify that detecting the hardware information further include sending, by the commissioning node, an operating system to the node to detect and collect hardware information of the node.

Example 12 may include any subject matter of Examples 9-11, and may further specify that generating the delta domain template further includes determining one or more configuration files associated with the plurality of applications.

Example 13 may include the subject matter of Example 12, and may further specify that generating the delta domain template further includes calculating a file distance from at least one of the one or more configuration files to the common domain template.

Example 14 may include the subject matter of Example 13, and may further specify that generating the delta domain template further includes generating the delta domain template based on the file distance.

Example 15 may include the subject matter of Example 13 or 14, and may further specify that generating the delta domain template further include merging the at least one of the one or more configuration files with the common domain template.

Example 16 may include any subject matter of Examples 12-15, and may further specify that the one or more configuration files, the common domain template, or the delta domain template comprises one or more extensible markup language (XML) files.

Example 17 is at least one storage medium, which may include a plurality of instructions configured to cause an apparatus, in response to execution of the instructions by the apparatus, to practice any subject matter of Examples 9-16.

Example 18 is an system for computing, which may include a node to be added to a computing cluster; and a commissioner node, coupled to the node, to commission the node to a domain in the computing cluster. The commissioner node may include a detector to detect hardware information of the node to be added to the domain, and a domain application configurator, coupled to the detector, to generate a delta domain template for the node from a common domain template of the computing cluster and information of the domain, the delta domain template to include information to provision a plurality of applications to the node, the plurality of applications to be offered by nodes of the domain.

Example 19 may include the subject matter of Example 18, and may further specify that the commissioner node further includes a partition configurator, coupled to the detector, to determine a partition plan with a plurality of partitions based on the hardware information, wherein the partition configurator is to determine a partition of the plurality of partitions to install the plurality of applications.

Example 20 may include the subject matter of Example 19, and may further specify that the computing cluster is a Hadoop cluster, wherein the common domain template includes setup information for a Hadoop distributed file system, and wherein the partition configurator is to determine another partition of the plurality of partitions to install the Hadoop distributed file system.

Example 21 may include any subject matter of Examples 18-20, and may further specify that the domain application configurator is to determine one or more configuration files associated with the plurality of applications, calculate a file distance from at least one of the one or more configuration files to the common domain template, and generate the delta domain template based on the file distance.

Example 22 may be an apparatus for computing. The apparatus may include means for detecting, by a commissioning node in a computing cluster, hardware information of a node to be added to a domain of the computing cluster means for generating, by the commissioning node, a delta domain template for the node based on a common domain template, domain information of the domain, and the hardware information; and means for provisioning or causing to be provisioned, by the commissioning node, a plurality of applications to the node based at least in part on the delta domain template.

Example 23 may include the subject matter of Example 22, and may further include means for determining, by the commissioning node, a partition plan with a plurality of partitions based on the hardware information; and means for determining, by the commissioning node, one of the plurality of partitions to install the plurality of applications.

Example 24 may include the subject matter of Example 22 or 23, and may further specify that means for detecting the hardware information further comprises means for sending, by the commissioning node, an operating system to the node to detect and collect hardware information of the node.

Example 25 may include any subject matter of Examples 22-24, and may further specify that means for generating the delta domain template further comprises means for determining one or more configuration files associated with the plurality of applications.

Example 26 may include the subject matter of Example 25, and may further specify that means for generating the delta domain template further comprises calculating a file distance from at least one of the one or more configuration files to the common domain template.

Example 27 may include the subject matter of Example 26, and may further specify that means for generating the delta domain template further comprises generating the delta domain template based on the file distance.

Example 28 may include the subject matter of Example 26 or 27, and may further specify that means for generating the delta domain template further comprises merging the at least one of the one or more configuration files with the common domain template.

Example 29 may include any subject matter of Examples 25-28, and may further specify the one or more configuration files, the common domain template, or the delta domain template comprises one or more extensible markup language (XML) files.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1.-24. (canceled)

25. An apparatus, comprising:
a detector to detect hardware information of a node to be added to a domain of a computing cluster; and
a domain application configurator, coupled to the detector, to generate a delta domain template for the node from a common domain template of the computing cluster and information of the domain, the delta domain template to include information to provision a plurality of applications to the node, the plurality of applications to be offered by nodes of the domain.

26. The apparatus according to claim 1 (25), further comprising:
a partition configurator, coupled to the detector, to determine a partition plan with a plurality of partitions based on the hardware information, wherein the partition configurator is to determine a partition of the plurality of partitions to install the plurality of applications.

27. The apparatus according to claim 2 (26), wherein the computing cluster is a Hadoop cluster, wherein the common domain template includes setup information for a Hadoop distributed file system, and wherein the partition configurator is to determine another partition of the plurality of partitions to install the Hadoop distributed file system.

28. The apparatus according to claim 1 (25), further comprising:
a provisioning configurator, coupled to the domain application configurator, to facilitate the node to install and configure the plurality of applications based on the delta domain template.

29. The apparatus according to claim 1 (25), wherein the domain application configurator is to determine one or more configuration files associated with the plurality of applications.

30. The apparatus according to claim 5 (29), wherein the domain application configurator is to calculate a file distance from at least one of the one or more configuration files to the common domain template.

31. The apparatus according to claim 6 (30), wherein the domain application configurator is to generate the delta domain template based on the file distance.

32. The apparatus according to claim 6 (30), wherein the domain application configurator is to generate the delta domain template by merging the at least one of the one or more configuration files to the common domain template.

33. A method, comprising:
detecting, by a commissioning node in a computing cluster, hardware information of a node to be added to a domain of the computing cluster;
generating, by the commissioning node, a delta domain template for the node based on a common domain template, domain information of the domain, and the hardware information; and
provisioning or causing to be provisioned, by the commissioning node, a plurality of applications to the node based at least in part on the delta domain template, the plurality of applications to be offered by nodes of the domain.

34. The method of claim 9 (33), further comprising:
determining, by the commissioning node, a partition plan with a plurality of partitions based on the hardware information; and
determining, by the commissioning node, one of the plurality of partitions to install the plurality of applications.

35. The method of claim 9 (33), wherein detecting the hardware information further comprises sending, by the commissioning node, an operating system to the node to detect and collect hardware information of the node.

36. The method of claim 9 (33), wherein generating the delta domain template further comprises determining one or more configuration files associated with the plurality of applications.

37. The method of claim 12 (36), wherein generating the delta domain template further comprises calculating a file distance from at least one of the one or more configuration files to the common domain template.

38. The method of claim 13 (37), wherein generating the delta domain template further comprises generating the delta domain template based on the file distance.

39. The method of claim 13 (37), wherein generating the delta domain template further comprises merging the at least one of the one or more configuration files with the common domain template.

40. The method of claim 12 (36), wherein the one or more configuration files, the common domain template, or the delta domain template comprises one or more extensible markup language (XML) files.

41. At least one non-transient storage medium, comprising:
a plurality of instructions configured to cause an apparatus, in response to execution of the instructions by the apparatus, to practice the method of claim 9 (33).

42. An system, comprising:
a node to be added to a computing cluster; and
a commissioner node, coupled to the node, to commission the node to a domain in the computing cluster,
wherein the commissioner node comprises a detector to detect hardware information of the node to be added to the domain, and a domain application configurator, coupled to the detector, to generate a delta domain template for the node from a common domain template of the computing cluster and information of the domain, the delta domain template to include information to provision a plurality of applications to the node, the plurality of applications to be offered by nodes of the domain.

43. The system according to claim 18 (42), wherein the commissioner node further comprises a partition configurator, coupled to the detector, to determine a partition plan with a plurality of partitions based on the hardware information, wherein the partition configurator is to determine a partition of the plurality of partitions to install the plurality of applications.

44. The system according to claim 19 (43), wherein the computing cluster is a Hadoop cluster, wherein the common domain template includes setup information for a Hadoop distributed file system, and wherein the partition configurator is to determine another partition of the plurality of partitions to install the Hadoop distributed file system.

45. The system according to claim 18 (42), wherein the domain application configurator is to determine one or more configuration files associated with the plurality of applications, calculate a file distance from at least one of the one or more configuration files to the common domain template, and generate the delta domain template based on the file distance.

46. An apparatus, comprising:
means for detecting, by a commissioning node in a computing cluster, hardware information of a node to be added to a domain of the computing cluster;
means for generating, by the commissioning node, a delta domain template for the node based on a common domain template, domain information of the domain, and the hardware information; and
means for provisioning or causing to be provisioned, by the commissioning node, a plurality of applications to the node based at least in part on the delta domain template.

47. The apparatus according to claim 22 (46), further comprising:
means for determining, by the commissioning node, a partition plan with a plurality of partitions based on the hardware information; and
means for determining, by the commissioning node, one of the plurality of partitions to install the plurality of applications.

48. The apparatus according to claim 22 (46), further comprising:
means for determining one or more configuration files associated with the plurality of applications;
means for calculating a file distance from at least one of the one or more configuration files to the common domain template; and
means for generating the delta domain template based on the file distance.
